(19) United States
(12) Patent Application Publication
(10) Pub. No.: US 2023/0136459 A1
(43) Pub. Date: May 4, 2023

(54) CHAINSAW GUIDE BAR MEASURING ATTACHMENT SYSTEMS AND METHODS

(71) Applicant: Janice Cowell, Rexford, MT (US)

(72) Inventor: Janice Cowell, Rexford, MT (US)

(21) Appl. No.: 17/452,633

(22) Filed: Oct. 28, 2021

(51) Int. Cl. B27B 17/00; B27B 17/02

(52) U.S. Cl. CPC B27B 17/0025; B27B 17/02

(57) ABSTRACT

Chainsaw guide bar measuring attachment systems and methods are provided. A measuring device for defining a cut location for a chainsaw may include a length indicator, an attachment portion for positioning through an aperture defined in a guide bar of the chainsaw, and a fastening assembly for coupling to the attachment portion. The fastening assembly may include a fastener and a magnet. The fastener may couple the fastening assembly to the attachment portion. The magnet may magnetically couple the fastening assembly to the guide bar. A system may include a chainsaw and the measuring device for defining a cut location for the chainsaw. Corresponding methods are also provided.

### TECHNICAL FIELD

One or more embodiments relate generally to chainsaw guide bar attachments and, more particularly, to systems and methods for a measuring device attachable to a chainsaw guide bar and configured to define a cut location for the chainsaw.

### BACKGROUND

Conventional systems and methods of measuring firewood lengths can be dangerous, inefficient, imprecise, or otherwise undesired. For example, some systems for measuring firewood lengths require multiple people or operators. Some devices are hard to install/remove, fall off easily, and/or are attached to less-than-ideal locations on a chainsaw. Therefore, there is a need in the art for systems and methods that address the above deficiencies, other deficiencies known in the industry, or at least offers an alternative to current techniques.

### SUMMARY

Systems and methods are provided for a chainsaw guide bar measuring attachment. According to one or more embodiments of the present disclosure, a measuring device is provided for attachment to a guide bar of a chainsaw. The measuring device may include one or more features allowing quick and secure attachment of the measuring device to a chainsaw guide bar. The measuring device may allow a user to efficiently measure out lengths of firewood to a desired length, such that the cut firewood has consistent or near consistent lengths.

According to one or more embodiments of the present disclosure, a measuring device for defining a cut location for a chainsaw is provided. The measuring device may include a length indicator, an attachment portion for positioning through an aperture defined in a guide bar of the chainsaw, and a fastening assembly for coupling to the attachment portion. The fastening assembly may include a fastener and a magnet. The fastener may couple the fastening assembly to the attachment portion. The magnet may magnetically couple the fastening assembly to the guide bar.

According to one or more embodiments of the present disclosure, a system is provided. The system may include a chainsaw and a measuring device for defining a cut location for the chainsaw. The chainsaw may include a guide bar having an aperture. The measuring device may include a length indicator, an adapter assembly coupled to the length indicator and including an attachment portion for positioning through the aperture of the guide bar, and a fastening assembly for coupling to the attachment portion of the adapter assembly to trap at least a portion of the guide bar between the adapter assembly and the fastening assembly. The fastening assembly may include a magnet for magnetically coupling the fastening assembly to the guide bar.

According to one or more embodiments of the present disclosure, a method of defining a cut location for a chainsaw is provided. The method may include attaching a measuring device to a guide bar of the chainsaw and using the measuring device to define a cut location for the chainsaw. The measuring device may include a length indicator having an end, an adapter assembly coupled to the length indicator and including an attachment portion, and a fastening assembly coupled to the attachment portion of the adapter assembly and including a fastener and a magnet. The fastener may couple the fastening assembly to the attachment portion. The magnet may magnetically couple the fastening assembly to the guide bar. The end of the length indicator may be positioned at an end of an item to be cut or at a previous cut location to define the cut location for the chainsaw.

Additional features are set forth in part in the description that follows and will become apparent to those skilled in the art upon examination of the specification and drawings or may be learned by the practice of the disclosed subject matter. A further understanding of the nature and advantages of the present disclosure may be realized by reference to the remaining portions of the specification and the drawings, which forms a part of this disclosure.

One of skill in the art will understand that each of the various aspects and features of the disclosure may advantageously be used separately in some instances, or in combination with other aspects and features of the disclosure in other instances. Accordingly, individual aspects can be claimed separately or in combination with other aspects and features. Thus, the present disclosure is merely exemplary in nature and is in no way intended to limit the claimed invention or its applications or uses. It is to be understood that structural and/or logical changes may be made without departing from the spirit and scope of the present disclosure.

The present disclosure is set forth in various levels of detail and no limitation as to the scope of the claimed subject matter is intended by either the inclusion or non-inclusion of elements, components, or the like in this summary. In certain instances, details that are not necessary for an understanding of the disclosure or that render other details difficult to perceive may have been omitted. Moreover, for the purposes of clarity, detailed descriptions of certain features will not be discussed when they would be apparent to those with skill in the art so as not to obscure the description of the present disclosure. The claimed subject matter is not necessarily limited to the arrangements illustrated herein, with the scope of the present disclosure is defined only by the appended claims.

### BRIEF DESCRIPTION OF THE DRAWINGS

The description will be more fully understood with reference to the following figures in which components may not be drawn to scale, which are presented as various embodiments of the measuring device described herein and should not be construed as a complete depiction of the scope of the measuring device and associated chainsaw system.

FIG. 1 illustrates a perspective view of a measuring device connected to a guide bar of a chainsaw, in accordance with an embodiment of the disclosure.

FIG. 2 illustrates an exploded view of the measuring device of FIG. 1, in accordance with an embodiment of the disclosure.

FIG. 3 illustrates a process of preparing a guide bar to receive a measuring device, in accordance with an embodiment of the disclosure.

FIG. 4 illustrates an attachment of a measuring device to a guide bar of a chainsaw, in accordance with an embodiment of the disclosure.

FIG. 5 illustrates use of the measuring device to define a cut location for a chainsaw, in accordance with an embodiment of the disclosure.

FIG. 6 illustrates a removal of a measuring device from a guide bar of a chainsaw, in accordance with an embodiment of the disclosure.

FIG. 7 illustrates an additional measuring device, in accordance with an embodiment of the disclosure.

FIG. 8 illustrates a process of defining a cut location for a chainsaw using a measuring device, in accordance with an embodiment of the disclosure.

Embodiments of the disclosure and their advantages are best understood by referring to the detailed description that follows. It should be appreciated that like reference numerals may be used to identify like elements illustrated in one or more of the figures.

### DETAILED DESCRIPTION

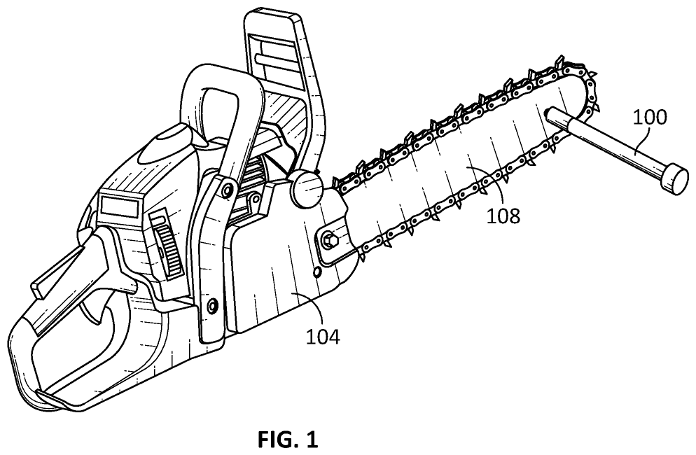

FIG. 1 illustrates a perspective view of a measuring device connected to a guide bar of a chainsaw, in accordance with an embodiment of the disclosure. According to the present disclosure, a measuring device 100 is provided that facilitates use of a chainsaw 104 to cut down fallen trees, limbs, or other items into logs or sticks of repeatable lengths. For example, the measuring device 100 described herein may allow a user to efficiently measure out lengths of firewood to a desired length. As a result, the cut firewood may have a consistent or near consistent length, aiding in stacking, packaging, storing, and/or use in a fireplace. The measuring device 100 may also improve productivity, as the measuring device 100 may allow quick and efficient measurement of firewood cut lengths without stopping.

The measuring device 100 may include a simple design, allowing the measuring device 100 to be attached to most, if not all, chainsaws. For example, as described more fully below, the measuring device 100 is designed for attachment to a guide bar 108 of the chainsaw 104. Depending on the embodiment, the measuring device 100 may be attached near the distal end of the guide bar 108. The measuring device 100 may easily and quickly attach to the guide bar 108, such as via a simple mechanism as described below. For example, the measuring device 100 may attach to the guide bar 108 using a threaded fastener (e.g., a nut, wingnut, bolt, etc.). The attachment means may increase a strength and/or stiffness of the measuring device 100 while also reducing twisting of the measuring device 100 (e.g., a twisting tending to loosen the measuring device 100).

As shown in FIG. 1, the measuring device 100 may extend laterally from the guide bar 108, such as orthogonal or near orthogonal from the guide bar 108, although other configurations are contemplated. Although illustrated as attached to the right side of the guide bar 108 (as viewed from a user's point of view when using the chainsaw 104), the measuring device 100 may be attached to the left side of the guide bar 108 based on user preference, site conditions, tree placement, user/bystander positioning, etc.

During use, the measuring device 100 may be positioned adjacent to a tree, log, or other item to be cut to define one or more cut locations for the chainsaw 104, as detailed below. For example, the measuring device 100 may be used to set a consistent or near consistent length between cuts along the tree or log. For instance, an initial cut may be defined by indexing the measuring device 100 against the end of the tree or log. Once a cut has been made on the tree or log, the next cut may be defined by indexing the measuring device 100 against the previous cut. This process may be repeated until the entire tree or log is cut down into consistent lengths.

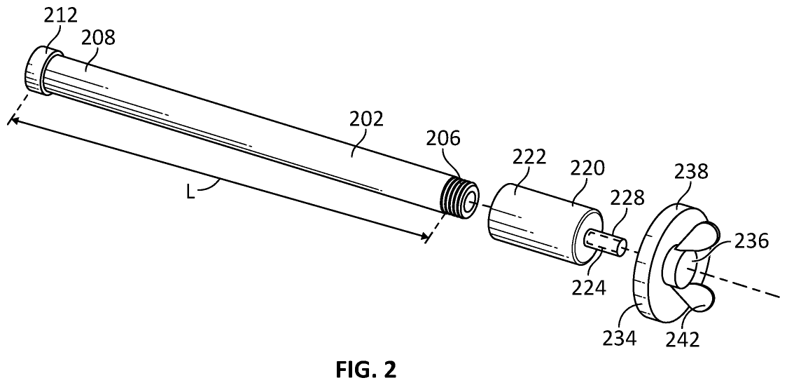

FIG. 2 illustrates an exploded view of the measuring device 100 of FIG. 1, in accordance with an embodiment of the disclosure. The measuring device 100 may include many configurations for defining a cut location for chainsaw 104. Referring to FIG. 2, the measuring device 100 may include a length indicator 202. The length indicator 202 may provide an indication of a proper or desired length for cutting an item (e.g., firewood logs) using chainsaw 104. For example, the length indicator 202 may have a length defined between a first end 206 and a second end 208, the length defining a length of cut. As shown, the first end 206 may be threaded, and the second end 208 may include a cap 212, although other configurations are contemplated.

The length indicator 202 may be formed of a first material easily cut by a chainsaw chain. In this manner, should the length indicator 202 be touched accidentally by another running chainsaw, the length indicator 202 will be cut or nicked without posing a safety hazard from flying debris or pulling the chainsaw 104 and/or user towards the chain of the other running chainsaw. In embodiments, the length indicator 202 may include or be formed from a polyvinyl chloride (PVC) pipe (e.g., ½ inch PVC pipe).

The length indicator 202 may have various lengths. For example, the length indicator 202 may be provided with a 12-inch length, a 14-inch length, a 16-inch length, or an 18-inch length, among other lengths. As a result, the length indicator 202 may be replaced with a second length indicator, the second length indicator having a different length. In some embodiments, the length indicator 202 may be cut down to a desired length.

With continued reference to FIG. 2, the measuring device 100 may include an adapter assembly 220. The adapter assembly 220 may be coupled to the length indicator 202. For example, the adapter assembly 220 may be threaded to the first end 206 of the length indicator 202. As shown, the adapter assembly 220 includes a body 222 and an attachment portion 224 extending from the body 222. The attachment portion 224 may be configured for positioning through an aperture defined in the guide bar 108, as detailed below. Positioning the attachment portion 224 through the guide bar 108 may at least partially attach the measuring device 100 to the guide bar 108, as further explained below.

The adapter assembly 220 may be formed of a second material different than the length indicator 202. For instance, the adapter assembly 220 may be formed of metal, such as steel, iron, stainless steel, brass, or other metals. In some embodiments, the attachment portion 224 may be a separate element connected to the body 222, or the attachment portion 224 may be formed integrally with the body 222. The attachment portion 224 may include or be defined by a threaded rod 228.

As shown, the measuring device 100 may include a fastening assembly 234 for coupling to the attachment portion 224 of the adapter assembly 220. The fastening assembly 234 may include many configurations, including a fastener 236 and a magnet 238. The fastener 236 may couple the fastening assembly 234 to the attachment portion 224 (e.g., via threaded engagement with the threaded rod 228). Depending on the embodiment, the fastener 236 may include a wing nut 242 for threading to the threaded rod 228 to secure the measuring device 100 to the guide bar 108. The magnet 238 may magnetically couple the fastening assembly 234 to the guide bar 108.

Attachment of the fastening assembly 234 to the adapter assembly 220 may trap at least a portion of the guide bar 108 between the adapter assembly 220 and the fastening assembly 234. For example, as described more fully below, at least a portion of the guide bar 108 may be configured to be trapped between the body 222 of the adapter assembly 220 and the magnet 238 of the fastening assembly 234. Such configurations may provide a secure attachment of the measuring device 100 to the guide bar 108. For instance, the attachment may provide sufficient lateral and/or rotational strength and stiffness.

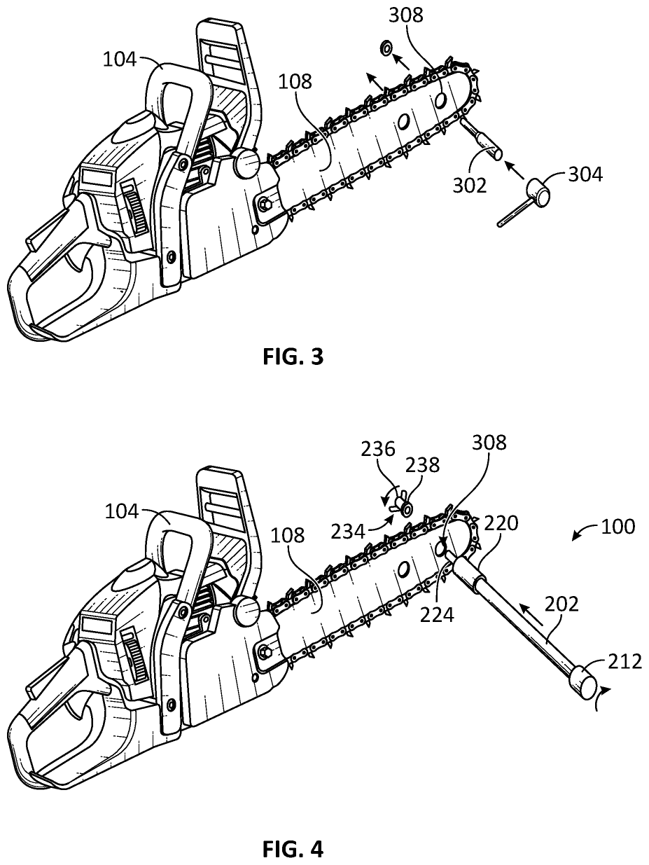

FIG. 3 illustrates a process of preparing guide bar 108 to receive measuring device 100, in accordance with an embodiment of the disclosure. Referring to FIG. 3, a punch 302 and hammer 304 may be used to punch out an aperture 308 in guide bar 108. For example, the aperture 308 may be formed by punching out an existing hole in guide bar 108. As shown, aperture 308 may be formed near a distal end of guide bar 108, although other configurations are contemplated.

FIG. 4 illustrates an attachment of measuring device 100 to guide bar 108, in accordance with an embodiment of the disclosure. Referring to FIG. 4, the measuring device 100 may be attached to guide bar 108 by inserting attachment portion 224 (e.g., threaded rod 228) of adapter assembly 220 through the aperture 308. The attachment portion 224 may be inserted until the body 222 of adapter assembly 220 bottoms out against one side of guide bar 108 (e.g., against the right side of guide bar 108 as shown in FIG. 4). Once the attachment portion 224 is inserted through aperture 308, the fastening assembly 234 may be secured to the attachment portion 224, such as via threading the wing nut 242 onto the threaded rod 228. The fastening assembly 234 may be threaded onto the attachment portion 224 until the fastening assembly 234 (e.g., magnet 238) bottoms out against the opposite side of guide bar 108 (e.g., against the left side of guide bar 108 as shown in FIG. 4). As a result, at least a portion of the guide bar 108 may be trapped, sandwiched, or positioned between the adapter assembly 220 and the fastening assembly 234. In embodiments, tightening the fastening assembly 234 may pull the adapter assembly 220 and magnet 238 against opposing sides of guide bar 108 to secure the measuring device 100 in place. The magnet 238 may strengthen the attachment of the measuring device 100 to the guide bar 108. For example, once the fastening assembly 234 is tightened, the magnet 238 may limit or reduce twisting of the measuring device 100 on the guide bar 108. As a result, the magnet 238 may limit or reduce undesired loosening of the fastening assembly 234.

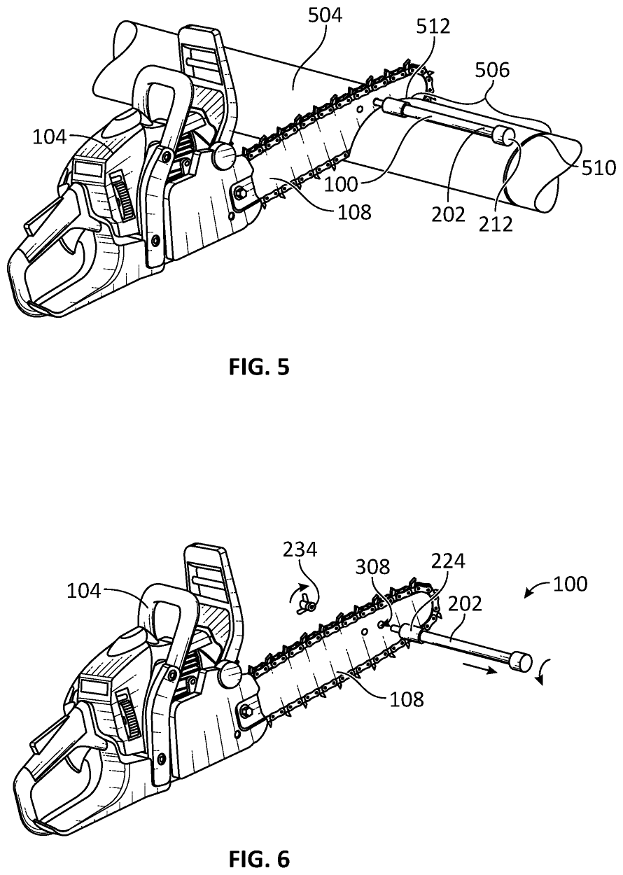

FIG. 5 illustrates use of the measuring device 100 to define a cut location for chainsaw 104, in accordance with an embodiment of the disclosure. The measuring device 100 may be used to cut a fallen tree 504 (or other item) into multiple sections or logs 506 of repeatable lengths. For example, the measuring device 100 may aid a user to set a consistent or near consistent length between cuts along the fallen tree 504. As shown, a first cut 510 may be made in the fallen tree 504. The chainsaw 104 may then be moved down the fallen tree 504 until the second end 208 of the measuring device 100 aligns with the first cut 510, upon which a second cut 512 may be made in the fallen tree 504. This process may be repeated until the entire fallen tree 504 is sectioned.

As shown, the first cut 510 and second cut 512 may be only partial cuts into the fallen tree 504, such that the partial cuts are alignment cuts only. Once the fallen tree 504 is sectioned with the partial cuts, the user can then go back and complete each cut, with either the measuring device 100 removed or still attached to the guide bar 108. For example, the alignment cuts may be made using the end or tip of the guide bar 108 where the measuring device 100 is located. The complete cuts can then be made near the bumper spikes of the chainsaw 104. Such embodiments are exemplary only, and the fallen tree 504 may be cut down using a different technique. For instance, each cut may be a complete cut initially, with the second end 208 of the measuring device 100 aligning with the freshly cut end of the fallen tree 504 to make the next cut.

FIG. 6 illustrates a removal of the measuring device 100 from the guide bar 108, in accordance with an embodiment of the disclosure. Removal of measuring device 100 from guide bar 108 may be accomplished by following the procedure outlined above in reverse order. For example, fastening assembly 234 may be removed from the adapter assembly 220, such as unthreaded from the threaded rod 228. Once the fastening assembly 234 is removed from the adapter assembly 220, the attachment portion 224 may be removed from the aperture 308 to remove the measuring device 100 from the guide bar 108.

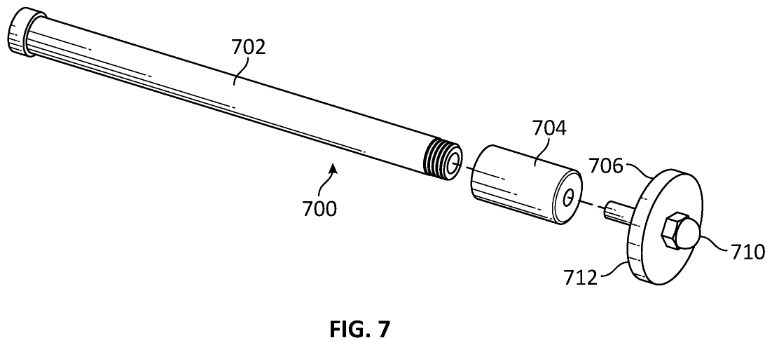

FIG. 7 illustrates an additional measuring device 700, in accordance with an embodiment of the disclosure. Except as otherwise noted below, the measuring device 700 illustrated in FIG. 7 may be similar to the measuring device 100 described above. For instance, measuring device 700 may include a length indicator 702, an adapter assembly 704, and a fastening assembly 706. The length indicator 702 may be similar to length indicator 202 described above. The adapter assembly 704 may be coupled to the length indicator 702, such as via threaded attachment.

The fastening assembly 706 may couple to the adapter assembly 704. The fastening assembly 706 may include a fastener 710 coupling the fastening assembly 706 to the adapter assembly 704, and a magnet 712 magnetically coupling the fastening assembly 706 to the guide bar 108. As shown, the fastener 710 may be a bolt for threading to the adapter assembly 704. In such embodiments, the bolt may be positioned within the aperture 308 of guide bar 108 to attach measuring device 700 to the guide bar 108, the attachment portion of adapter assembly 704 being a female threaded portion to receive the bolt.

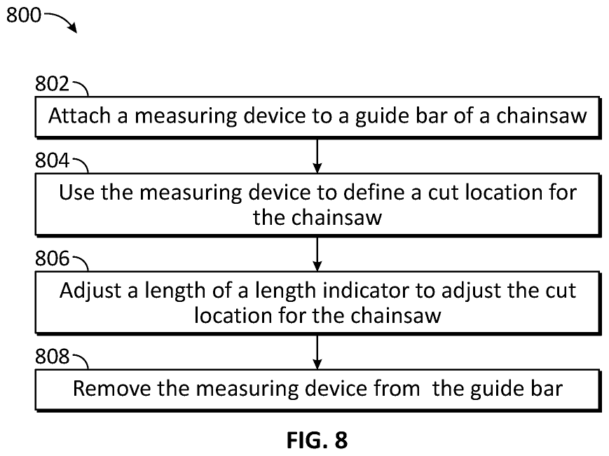

FIG. 8 illustrates a process 800 of defining a cut location for a chainsaw using a measuring device, in accordance with an embodiment of the disclosure. Process 800 is illustrated as a set of operations or steps and is described with reference to FIGS. 1-7, although process 800 may be applied to other embodiments not illustrated in FIGS. 1-7. One or more steps that are not expressly illustrated in FIG. 8 may be included before, after, in between, or as part of the illustrated steps.

In block 802, process 800 includes attaching a measuring device to a guide bar of a chainsaw. The measuring device may be similar to measuring device 100 and/or measuring device 700 described above. For instance, the measuring device may include a length indicator having an end, an adapter assembly coupled to the length indicator and comprising an attachment portion, and a fastening assembly coupled to the attachment portion of the adapter assembly and including a fastener and a magnet. The fastener may couple the fastening assembly to the attachment portion. The magnet may magnetically couple the fastening assembly to the guide bar.

Block 802 may include positioning the attachment portion through an aperture defined in the guide bar of the chainsaw. Block 802 may include defining the aperture in the guide bar, such as via a punch, drill, or the like. Block 802 may include trapping at least a portion of the guide bar between the adapter assembly and the magnet of the fastening assembly.

In block 804, process 800 may include using the measuring device to define a cut location for the chainsaw. The end of the length indicator may be positioned at an end of an item to be cut or at a previous cut location to define the cut location for the chainsaw. The item to be cut may be a fallen tree, branch, limb, post, or other item.

In block 806, process 800 may include adjusting a length of the length indicator to adjust the cut location for the chainsaw. Block 806 may include replacing the length indicator with a second length indicator, the second length indicator having a length different than the length indicator. Block 806 may include cutting the length indicator to a different length.

In block 808, process 800 may include removing the measuring device from the guide bar. For example, the fastening assembly may be removed from the adapter assembly, and the measuring device may be removed from the guide bar.

All relative and directional references (including up, down, upper, lower, top, bottom, side, front, rear, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

The present disclosure teaches by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A measuring device for defining a cut location for a chainsaw, the measuring device comprising:
a length indicator;
an attachment portion for positioning through an aperture defined in a guide bar of the chainsaw; and
a fastening assembly for coupling to the attachment portion and comprising a fastener and a magnet, the fastener coupling the fastening assembly to the attachment portion, and the magnet magnetically coupling the fastening assembly to the guide bar.

2. The measuring device of claim 1, further comprising an adapter assembly coupled to the length indicator, the adapter assembly comprising the attachment portion.

3. The measuring device of claim 2, wherein at least a portion of the guide bar is configured to be trapped between the adapter assembly and the magnet of the fastening assembly.

4. The measuring device of claim 3, wherein:
the attachment portion comprises a threaded rod for positioning through the aperture defined in the guide bar, the threaded rod extending from a body of the adapter assembly, the guide bar configured to be trapped between the body of the adapter assembly and the magnet of the fastening assembly; and
the fastener comprises a wing nut for threading to the threaded rod to secure the measuring device to the guide bar.

5. The measuring device of claim 2, wherein:
the length indicator is formed of a first material easily cut by a chainsaw chain; and
the adapter assembly is formed of a second material different from the first material.

6. The measuring device of claim 1, wherein the length indicator is a polyvinyl chloride (PVC) pipe having a length defining a length of cut.

7. The measuring device of claim 6, wherein an end of the PVC pipe is coupled to at least one of a cap or an adapter.

8. A system comprising:
a chainsaw guide bar; and
the measuring device of claim 1 for attachment to the chainsaw guide bar.

9. A chainsaw comprising the measuring device of claim 1.

10. A system comprising:
a chainsaw comprising a guide bar having an aperture; and
a measuring device for defining a cut location for the chainsaw, the measuring device comprising:
a length indicator,
an adapter assembly coupled to the length indicator and comprising an attachment portion for positioning through the aperture of the guide bar, and
a fastening assembly for coupling to the attachment portion of the adapter assembly to trap at least a portion of the guide bar between the adapter assembly and the fastening assembly, the fastening assembly comprising a magnet for magnetically coupling the fastening assembly to the guide bar.

11. The system of claim 10, wherein the fastening assembly comprises a wingnut for threaded engagement with the attachment portion of the adapter assembly.

12. The system of claim 10, wherein:
the length indicator comprises a polyvinyl chloride (PVC) pipe having a length defining a length of cut, the PVC pipe having a threaded end; and
the adapter assembly comprises a metal body threadingly engaged to the threaded end of the PVC pipe.

13. The system of claim 12, further comprising a cap coupled to a second end of the PVC pipe.

14. A method of defining a cut location for a chainsaw, the method comprising:
attaching a measuring device to a guide bar of the chainsaw, the measuring device comprising:
a length indicator having an end,
an adapter assembly coupled to the length indicator and comprising an attachment portion, and
a fastening assembly coupled to the attachment portion of the adapter assembly and comprising a fastener and a magnet, the fastener coupling the fastening assembly to the attachment portion, and the magnet magnetically coupling the fastening assembly to the guide bar; and
using the measuring device to define a cut location for the chainsaw, the end of the length indicator positioned at an end of an item to be cut or at a previous cut location to define the cut location for the chainsaw.

15. The method of claim 14, wherein the attaching the measuring device to the guide bar comprises positioning the attachment portion through an aperture defined in the guide bar of the chainsaw.

16. The method of claim 15, wherein the attaching the measuring device to the guide bar comprises defining the aperture in the guide bar.

17. The method of claim 15, wherein the attaching the measuring device to the guide bar comprises trapping at least a portion of the guide bar between the adapter assembly and the magnet of the fastening assembly.

18. The method of claim 14, further comprising adjusting a length of the length indicator to adjust the cut location for the chainsaw.

19. The method of claim 17, wherein the adjusting the length of the length indicator comprises:
replacing the length indicator with a second length indicator, the second length indicator having a length different than the length indicator; or
cutting the length indicator to a different length.

20. The method of claim 14, further comprising removing the measuring device from the guide bar.
